(19) United States
(12) Patent Application Publication
(10) Pub. No.: US 2012/0171994 A1
(43) Pub. Date: Jul. 5, 2012

(54) METHOD AND SYSTEM OF SECURED WIRELESS COMMUNICATION

(75) Inventors: Ravikesh SINGH, Noida (IN); Vinay JOSHI, Noida (IN)

(73) Assignee: SAMSUNG ELECTRONICS CO. LTD., Suwon-si (KR)

(21) Appl. No.: 13/341,242

(22) Filed: Dec. 30, 2011

(30) Foreign Application Priority Data
Dec. 30, 2010 (IN) 4032/CHE/2010
Dec. 20, 2011 (KR) 10-2011-0137930

(51) Int. Cl. H04W 12/00

(52) U.S. Cl. 455/410

(57) ABSTRACT

A method and a system for secured wireless communication are provided. The method for secured wireless communication includes connecting a first electronic device with a second electronic device via a network, detecting, by the second electronic device, a status of a particular mode of the second electronic device, and transmitting, to the first electronic device, a status of unsecured communication of the second electronic device according to the status of the particular mode of the second electronic device.

### PRIORITY

This application claims the benefit under 35 U.S.C. §119(a) of an Indian patent application filed in the Indian Patent Office on Dec. 30, 2010 and assigned Serial No. 4032/CHE/2010, and of a Korean patent application filed in the Korean Intellectual Property Office on Dec. 20, 2011 and assigned Serial No. 10-2011-0137930, the entire disclosure of each of which is hereby incorporated by reference.

### BACKGROUND OF THE INVENTION

1. Field of the Invention

The present invention relates to a communication system. More particularly, the present invention relates to a secured wireless communication system.

2. Description of the Related Art

In the related art, wireless communication, for example cellular communication, includes a channel for communication between two users with electronic devices via a network. Generally, the communication channel used for wireless communication is a secured channel. However, the communication systems that are currently available cannot keep track of security at the other end user. Furthermore, real time notification of the status of security at the other end of the communication channel is not available.

### SUMMARY OF THE INVENTION

Aspects of the present invention are to address at least the above-mentioned problems and/or disadvantages and to provide at least the advantages described below. Accordingly, an aspect of the present invention is to provide a method and system for secured wireless communication by which the status of security can be notified from a counterpart electronic device connected to a network.

According to an aspect of the present invention, a method of secured wireless communication is provided. The method includes connecting a first electronic device with a second electronic device via a network, detecting, by the second electronic device, a status of a particular mode of the second electronic device, and transmitting to the first electronic device a status of unsecured communication of the second electronic device according to the status of the particular mode of the second electronic device.

According to another aspect of the present invention, a system for secured wireless communication is provided. The system includes a first electronic device for receiving a status of unsecured communication of a second electronic device connected via a network, and the second electronic device for detecting a status of a particular mode of the second electronic device and for transmitting the status of unsecured communication of the second electronic device to the first electronic device according to the status of the particular mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram for describing a communication environment in accordance with an exemplary embodiment of the present invention;

FIGS. 2A through 3B are diagrams for describing the status of security in a communication environment in accordance with an exemplary embodiment of the present invention;

FIGS. 4 and 5 are diagrams for describing a process of notifying the status of security of communication according to subscription for secured communication in a communication environment in accordance with an exemplary embodiment of the present invention; and

FIG. 6 is a flowchart illustrating a process of notifying the status of security of communication in a communication environment in accordance with an exemplary embodiment of the present invention.

Throughout the drawings, it should be noted that like reference numbers are used to depict the same or similar elements, features, and structures.

### DETAILED DESCRIPTION OF THE EXEMPLARY EMBODIMENT

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

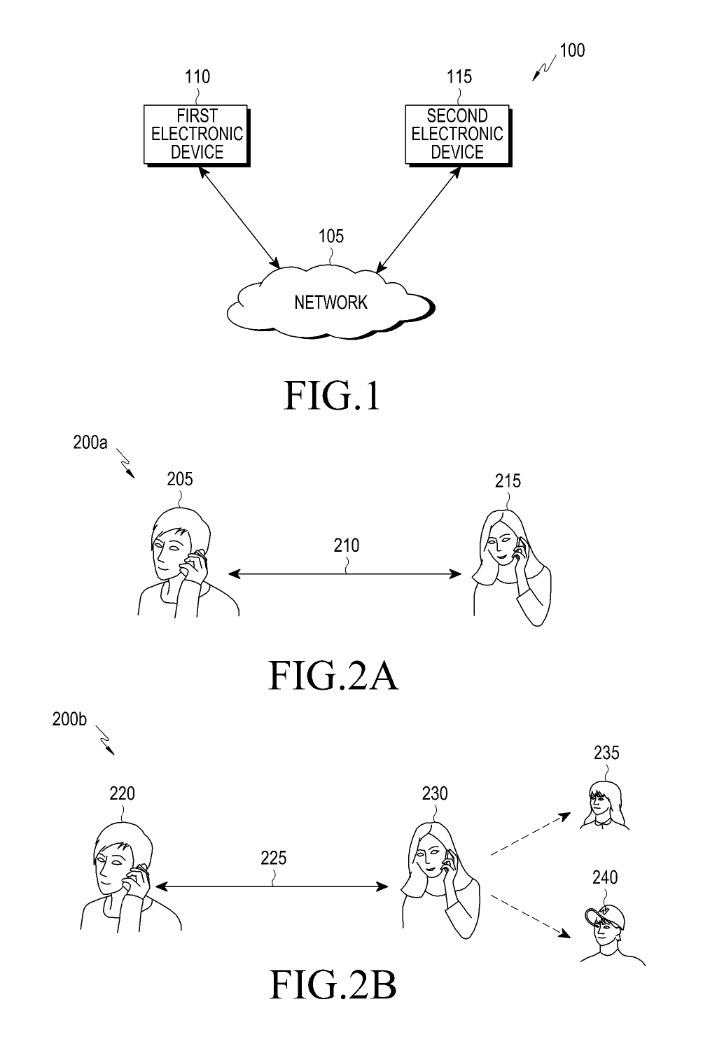

FIG. 1 is a diagram for describing a communication environment in accordance with an exemplary embodiment of the present invention.

Referring to FIG. 1, the environment 100 includes a network 105. The environment 100 further includes one or more electronic devices, for example a first electronic device 110, and a second electronic device 115 which can communicate with each other through the network 105. Examples of the first and the second electronic devices 110 and 115 include, but are not limited to, computers, mobile devices, laptops, palmtops, Personal Digital Assistants (PDAs), and the like. The electronic devices 110 and 115 can also communicate with each other through the network 105.

The first electronic device 110 connects to the second electronic device 115 via network for communication.

According to an exemplary embodiment of the present invention, the first electronic device 110 can send or receive data for communication.

The first electronic device 110 and the second electronic device 115 are configured to send and receive data via the network 105. The network 105 is configured to connect the first electronic device 110 and the second electronic device 115 for communication between the first electronic device 110 and the second electronic device 115.

A platform is configured in the first electronic device 110 and the second electronic device 115, wherein the first electronic device 110 and the second electronic device 115 are in the same platform. For example, the platform can be Android, Bada, Symbian, Windows, Linux, and the like. The platform is configured to detect and notify of an unsecured communication between the first electronic device 110 and the second electronic device 115.

According to an exemplary embodiment of the present invention, the network 105 includes a wireless network for communication. For example, the network 105 can be a Global System for Mobile communication (GSM) network, a Code Division Multiple Access (CDMA) network, and the like.

According to an exemplary embodiment of the present invention, the unsecured communication is detected by monitoring a particular mode of the second electronic device 115, that is, a first mode and a second mode. The first mode of the second electronic device 115 is the status of a speaker mode of the second electronic device 115. The second mode of the second electronic device 115 is the status of a voice recorder mode of the second electronic device 115.

According to an exemplary embodiment of the present invention, the unsecured mode of communication in the first mode is when the speaker mode of the second electronic device 115 is switched “on”. The secured mode of communication in the first mode is when the speaker mode of the second electronic device 115 is switched off

According to an exemplary embodiment of the present invention, the unsecured mode of communication in the second mode is when the voice recorder mode of the second electronic device 115 is switched “on”. The secured mode of communication in the second mode is when the voice recorder mode of the second electronic device 115 is switched off

The platform configured in the first electronic device 110 and the second electronic device 115 detects the status of the first mode and the status of the second mode of the second electronic device 115 and notifies the first electronic device 110 in case of an unsecured communication.

According to an exemplary embodiment of the present invention, the platform notifies the first electronic device 110 via a Short Message Service (SMS), a General Packet Radio Service (GPRS), and the like.

The platform configured in the second electronic device 115 notifies the first electronic device 110 by a two-digit status code, wherein a first digit represents the status of the first mode and a second digit represents the status of the second mode. For example:

TABLE 1

| | Speaker Mode | Voice Recorder |
|---|---|---|
| Status Code | (B) | (B) |
| 00—Secure | Off | Off |
| 01—Unsafe | Off | On |
| 10—Unsafe | On | Off |
| 11—Highest | On | On |
| level of security | | |
| breach | | |

The first electronic device 110 includes a display to display the status code sent by the platform of the second electronic device 115 to notify of the unsecured communication.

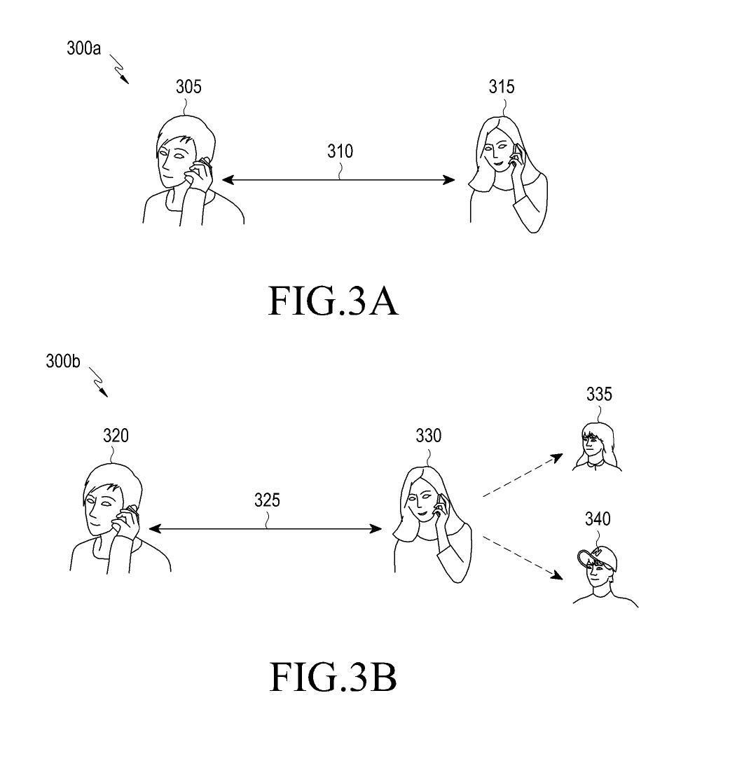

FIGS. 2A through 3B are diagrams for describing a type of the status of security in a communication environment in accordance with an exemplary embodiment of the present invention.

FIG. 2A shows a communication environment 200a of a zero level, which is a security breach situation, in accordance with an exemplary embodiment of the present invention.

A user at the first electronic device 205 connects establishes a communication 210 with a user at the second electronic device 215 via a network.

The user at the first electronic device 205 is unaware of the first mode and the second mode of the second electronic device 215. The platform configured in the second electronic device 215 detects the status of the second electronic device 215.

Currently, the user at the second electronic device 215 has switched off the first mode, that is the speaker mode, and the second mode, that is the voice recorder mode as shown in Table 2.

TABLE 2

| Status Code | Speaker Mode (B) | Voice Recorder (B) |
|---|---|---|
| 00—Secure | Off | Off |

The platform of the second electronic device 215 detects the secured communication and notifies the user at the first electronic device 205, through an SMS, a GPRS, and the like, including a status code “00” indicating the status of secured communication.

FIG. 2B is a diagram for describing an unsecured communication environment 200b, in accordance with an exemplary embodiment of the present invention.

The user at the first electronic device 220 connects establishes a communication 225 with the user at the second electronic device 230 via a network.

The user at the first electronic device 220 is unaware of the status of the first mode and the second mode of the second electronic device 230. The platform configured in the second electronic device 230 detects the status of the second electronic device 230.

Currently, the user at the second electronic device 230 has switched “on” the first mode, that is the speaker mode, and switched off the second mode, that is the voice recorder mode.

A person 235 and a person 240 may perform the communication with the user of the first electronic device 220 through the second electronic device 230 whose speaker mode is switched “on”, and hence the current communication is in an unsecured status.

Therefore, the platform of the second electronic device 230 detects the unsecured communication and hence notifies the user at the first electronic device 220 with the two-digit status code representing the first and the second mode of communication as shown in Table 3.

TABLE 3

| Status Code | Speaker Mode (B) | Voice Recorder (B) |
|---|---|---|
| 10—Unsecured | On | Off |

The user at the first electronic device 220 receives notification, via an SMS, a GPRS, and the like, regarding the status of unsecure communication and is made aware of the type of security breach.

FIG. 3A is a diagram for describing an unsecured communication environment 300a, in accordance with an exemplary embodiment of the present invention.

The user at the first electronic device 305 establishes a communication 310 with the user at the second electronic device 315 via a network.

The user at the first electronic device 305 is unaware of the first mode and the second mode of the second electronic device 315. Therefore, the platform configured in the second electronic device 315 detects the status of the second electronic device 315.

In this case, the user at the second electronic device 315 has switched off the first mode, that is the speaker mode, and switched “on” the second mode, that is the voice recorder mode.

Therefore, the platform of the second electronic device 315 detects the unsecured communication and hence notifies the user at the first electronic device 305 with the two-digit status code representing the first and the second mode of communication as shown in Table 4.

TABLE 4

| Status Code | Speaker Mode (B) | Voice Recorder (B) |
|---|---|---|
| 01—Unsecured | Off | On |

The user at the first electronic device 305 receives notification, via SMS, GPRS, and the like, regarding the status of unsecure communication and is made aware of the type of security breach.

FIG. 3B is a diagram for describing an unsecured communication environment 300b, in accordance with an exemplary embodiment of the present invention.

The user at the first electronic device 320 establishes a communication 325 with the user at the second electronic device 330 via a network.

The user at the first electronic device 320 is unaware of the first mode and the second mode of the second electronic device 330. The platform configured in the second electronic device 330 detects the status of the second electronic device 330.

In this case, the user at the second electronic device 330 has switched “on” the first mode, that is the speaker mode, and switched “on” the second mode, that is the voice recorder mode.

A person 335 and a person 340 may perform communication with the user of the first electronic device 320 through the second electronic device 330 whose speaker mode is switched “on”, and hence the current communication is in an unsecured status.

The platform of the second electronic device 330 detects the unsecured communication and hence notifies the user at the first electronic device 320 with the two-digit status code representing the first and the second mode of communication as shown in Table 5.

TABLE 5

| Status Code | Speaker Mode (B) | Voice Recorder (B) |
|---|---|---|
| 11—Highest level | On | On |
| of security breach | | |

The user at the first electronic device 320 receives notification, via an SMS, a GPRS, and the like, regarding the status of unsecure communication and is made aware of the type of security breach.

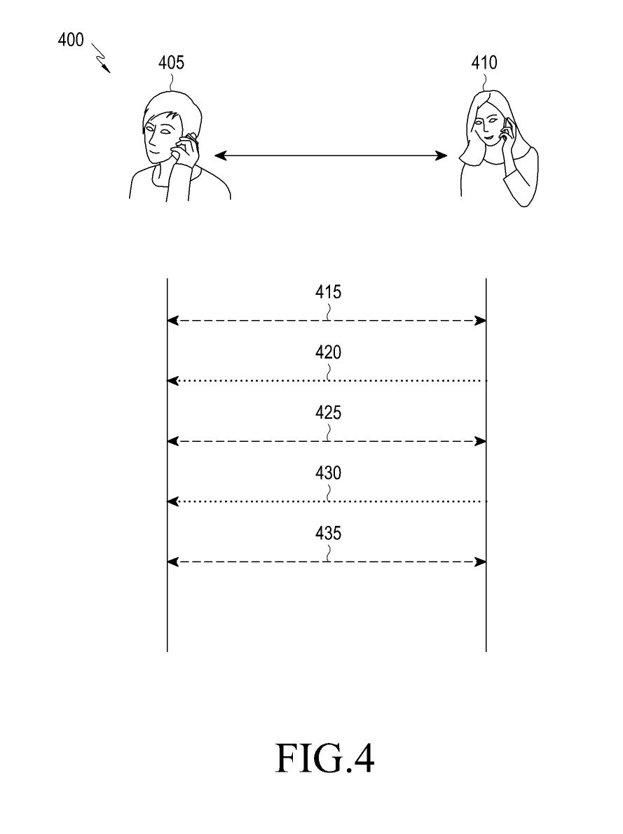

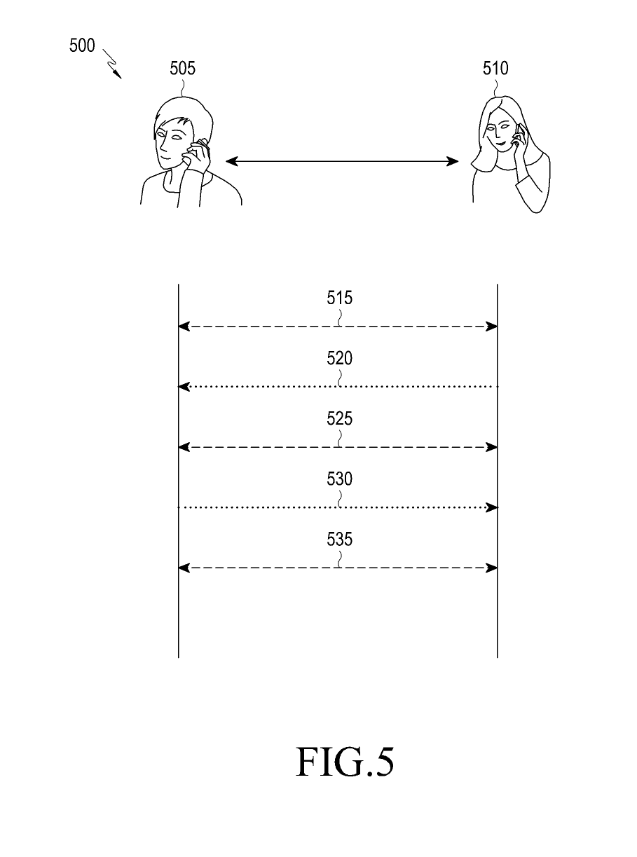

FIGS. 4 and 5 are diagrams for describing a process of notifying the status of security of communication according to subscription for secured communication in a communication environment in accordance with an exemplary embodiment of the present invention.

FIG. 4 is a diagram for describing a process of notifying the status of security of communication when either of two electronic devices that have established a communication has subscribed for secured communication in a communication environment 400, in accordance with an exemplary embodiment of the present invention.

A user at a first electronic device 405 establishes a communication with a user at a second electronic device 410 via a network. The user at the first electronic device 405 communicates with the user the second electronic device 410 through the network.

In this case, the user at the first electronic device 405 has subscribed for secured communication whereas the user at the second electronic device 410 has not subscribed for the secured communication.

The platform of the second electronic device 410 detects the status of the first mode and the second mode of the second electronic device 410. The platform detects the first mode or the second mode, that is, the speaker mode or the voice recorder mode switched “on” by the user at the second electronic device 410 in step 415. The platform notifies the user at the first electronic device 405, via an SMS, a GPRS, and the like, about the status of the first mode and the second mode of the communication in step 420.

The platform again detects the status of the first mode and the second mode of the second electronic device 410. The platform detects that the first mode or the second mode is switched off, that is, the speaker mode or the voice recorder mode is switched off by the user of the second electronic device 410 in step 425. The platform notifies the user at the first electronic device 405, via an SMS, a GPRS, and the like, about the status in step 430.

The platform again detects the status of the first mode and the second mode of the second electronic device 410 in step 435.

The platform detects the status of communication of the second electronic device 410 throughout the communication between the first electronic device 405 and the second electronic device 410 and notifies the first electronic device 405.

FIG. 5 is a diagram for describing a process of notifying the status of security of communication when both of two electronic devices that have established a communication have subscribed for secured communication in a communication environment 500, in accordance with an exemplary embodiment of the present invention.

A user at a first electronic device 505 establishes a communication with a user at a second electronic device 510 via a network. The user at the first electronic device 505 communicates with the user at the second electronic device 510 through the network.

The user at the first electronic device 505 and the user at the second electronic device 515 has subscribed for secured communication.

The platform of the second electronic device 510 detects the status of the first mode and the second mode of the second electronic device 510 in step 515. The platform detects that the first mode or the second mode, that is, the speaker mode or the voice recorder mode, is switched “on” by the user at the second electronic device 510. The platform notifies the user at the first electronic device 505, via an SMS, a GPRS, and the like, about the status of the first mode and the second mode of the communication in step 520.

The platform of the first electronic device 505 again detects the status of the first mode and the second mode of the first electronic device 505. The platform detects that the first mode or the second mode is switched “on”, that is, the speaker mode or the voice recorder mode is switched “on” by the user, at the first electronic device 505 in step 525. The platform notifies the user at the second electronic device 510, via an SMS, a GPRS, and the like, about the status of the first mode and the second mode of the communication in step 530.

The platform of the second electronic device 510 again detects the status of the first mode and the second mode of the second electronic device 510 in step 535.

In an exemplary embodiment of the present invention, the platform detects the status of communication throughout the communication.

The platform equally configured in the first electronic device 505 and the second electronic device 510 detects the status of communication between the first electronic device 505 and the second electronic device 510 throughout the communication between the first electronic device 405 and the second electronic device 410, and notifies the second electronic device 510 and the first electronic device 505.

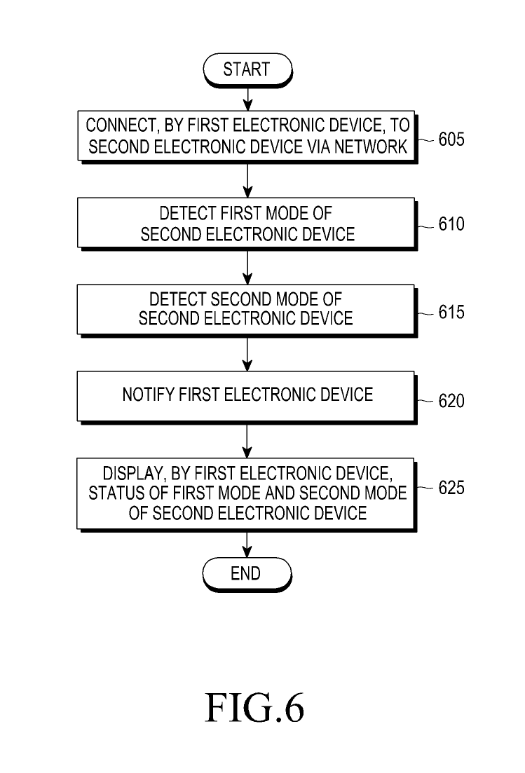

FIG. 6 is a flowchart illustrating a process of notifying the status of security of communication in a communication environment in accordance with an exemplary embodiment of the present invention.

Referring to FIG. 6, in step 605, the first user at the first electronic device wishes to communicate with the user at the second electronic device. The user at the first electronic device connects with the user at the second electronic device via a communication a network.

In step 610, the platform of the second electronic device detects the first mode of the second electronic device. In this state, the first mode of the second electronic device indicates the status of the speaker mode of the second electronic device.

In step 615, the platform detects the second mode of the second electronic device. In this state, the second mode of the second electronic device indicates the status of the voice recorder mode.

In step 620, the platform notifies the first electronic device with respect to the status of the first mode and the second mode of the second electronic device. The unsecured communication is detected by monitoring the first mode and the second mode of the second electronic device. The first mode of the second electronic device indicates the status of a speaker mode of the second electronic device. The second mode of the second electronic device indicates the status of a voice recorder mode of the second electronic device. In step 625, the status of the first mode and the second mode of the second electronic device are displayed by the first electronic device.

According to an exemplary embodiment of the present invention, the unsecured mode of communication in the first mode is when the speaker mode of the second electronic device is switched “on”. The secured mode of communication in the first mode is when the speaker mode of the second electronic device is switched off

According to an exemplary embodiment of the present invention, the unsecured mode of communication in the second mode is when the voice recorder mode of the second electronic device is switched “on”. The secured mode of communication in the second mode is when the voice recorder mode of the second electronic device is switched “off”.

The platform configured in the second electronic device detects the status of the first mode and the status of the second mode of the second electronic device and notifies the first electronic device in case of unsecured communication.

According to an exemplary embodiment of the present invention, the platform notifies the first electronic device of the status of security of communication via an SMS, a GPRS, and the like.

According to an exemplary embodiment of the present invention, the platform notifies the first electronic device by a two-digit status code, wherein a first digit represents the status of the first mode and a second digit represents the status of the second mode as shown in the foregoing Table 1.

The first electronic device indicates the notification sent by the platform for the status of the mode of communication. In an exemplary implementation, the indication is provided on a display device. In this case, the first electronic device determines a type of unsecured communication from the status code included in an SMS, a GPRS, and the like, and displays the determined type of unsecured communication on the display device.

In an exemplary implementation, if the status code is “01”, the first electronic device indicates that the voice recorder mode of the second electronic device is switched “on”; if the status code is “10”, the first electronic device indicates that the speaker mode of the second electronic device is switched “on”; and if the status code is “11”, the first electronic device indicates that the speaker mode and the voice recorder mode of the second electronic device are switched “on”.

By providing the method and system of secured wireless communication, the status of security communication of a counterpart device connected via a network can be notified in real time, allowing a device to know in real time whether a currently connected communication is secured.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for secured wireless communication, the method comprising:
connecting a first electronic device with a second electronic device via a network;
detecting, by the second electronic device, a status of a particular mode of the second electronic device; and
transmitting, to the first electronic device, a status of unsecured communication of the second electronic device according to the status of the particular mode of the second electronic device.

2. The method of claim 1, wherein the detecting of the status of the particular mode comprises:
detecting a switched-on/off status of a first mode indicating a speaker mode; and
detecting a switched-on/off status of a second mode indicating a voice recorder mode,
wherein the first mode and the second mode are included in the particular mode.

3. The method of claim 1, wherein the transmitting to the first electronic device of the status of unsecured communication of the second electronic device comprises notifying the first electronic device of the status of unsecured communication if, in the second electronic device, a first mode is switched off and a second mode is switched on.

4. The method of claim 1, wherein the transmitting to the first electronic device of the status of unsecured communication of the second electronic device comprises notifying the first electronic device of the status of unsecured communication if, in the second electronic device, a first mode is switched on and a second mode is switched off

5. The method of claim 1, wherein the transmitting to the first electronic device of the status of unsecured communication of the second electronic device comprises notifying the first electronic device of the status of unsecured communication if, in the second electronic device, a first mode is switched on and a second mode is switched on.

6. The method of claim 1, wherein the transmitting to the first electronic device of the status of unsecured communication of the second electronic device comprises:
transmitting, by the second electronic device, the status of unsecured communication of the second electronic device to the first electronic device through a Short Message Service (SMS) or a General Packet Radio Service (GPRS),
wherein a status code representing a type of the unsecured communication of the second electronic device is stored in the SMS or the GPRS.

7. The method of claim 1, wherein the status code comprises two digits, a first digit of which indicates a status of a first mode and a second digit of which indicates a status of a second mode.

8. The method of claim 1, wherein the same platform is configured in the first electronic device and the second electronic device, and the platform of the second electronic device detects the status of the particular mode of the second electronic device.

9. The method of claim 1, further comprising indicating, by the first electronic device, the status of unsecured communication of the second electronic device upon receiving the status of unsecured communication of the second electronic device from the second electronic device.

10. The method of claim 9, wherein the indicating of the status of unsecured communication comprises displaying the status of unsecured communication.

11. The method of claim 10, wherein the displaying of the status of unsecured communication comprises:
determining, by the first electronic device, a type of the status of unsecured communication through a status code received from the second electronic device;
displaying that a voice recorder mode of the second electronic device is switched on, if the status code is “01”;
displaying that a speaker mode of the second electronic device is switched on, if the status code is “10”; and
displaying that the voice recorder mode and the speaker mode of the second electronic device are switched on, if the status code is “11”.

12. A system for secured wireless communication, the system comprising:
a first electronic device for receiving a status of unsecured communication of a second electronic device connected via a network; and
the second electronic device for detecting a status of a particular mode of the second electronic device and for transmitting the status of unsecured communication of the second electronic device to the first electronic device according to the status of the particular mode.

13. The system of claim 12, wherein the second electronic device detects a switched-on/off status of a first mode indicating a speaker mode and detects a switched-on/off status of a second mode indicating a voice recorder mode, the first mode and the second mode being included in the particular mode.

14. The system of claim 12, wherein the second electronic device notifies the first electronic device of the status of unsecured communication, if, in the second electronic device, at least one of a first mode is switched off and a second mode is switched on, the first mode is switched on and the second mode is switched off, and the first mode is switched on and the second mode is switched on.

15. The system of claim 12, wherein the second electronic device transmits the status of unsecured communication of the second electronic device to the first electronic device through a Short Message Service (SMS) or a General Packet Radio Service (GPRS), and a status code representing a type of the unsecured communication of the second electronic device is stored in the SMS or the GPRS.

16. The system of claim 15, wherein the status code comprises two digits, a first digit of which indicates a status of a first mode and a second digit of which indicates a status of a second mode.

17. The system of claim 12, wherein the same platform is configured in the first electronic device and the second electronic device, and the platform of the second electronic device detects the status of the particular mode of the second electronic device.

18. The system of claim 12, wherein the first electronic device indicates the status of unsecured communication of the second electronic device, upon receiving the status of unsecured communication of the second electronic device from the second electronic device.

19. The system of claim 18, wherein the first electronic device indicates the status of unsecured communication of the second electronic device displaying the status of unsecured communication of the second electronic device.

20. The system of claim 19, wherein the first electronic device determines a type of the status of unsecured communication through a status code received from the second electronic device, displays that a voice recorder mode of the second electronic device is switched on if the status code is “01”, displays that a speaker mode of the second electronic device is switched on if the status code is “10”, and displays that the voice recorder mode and the speaker mode of the second electronic device are switched on if the status code is “11”.
